(19) United States
(12) Patent Application Publication
(10) Pub. No.: US 2004/0080553 A1
(43) Pub. Date: Apr. 29, 2004

(54) Apparatus and method for adjusting gap of ink-jet print head

(75) Inventor: Jung-Hwan Kim, Yongin-City (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/425,742

(22) Filed: Apr. 30, 2003

(30) Foreign Application Priority Data
Oct. 28, 2002 (KR) 2002-65865

(51) Int. Cl. B41J 25/308

(52) U.S. Cl. 347/8

(57) ABSTRACT

An apparatus and method of adjusting a gap of a print head of an ink-jet printer, in which the gap between the print head and printing paper is automatically detected and then maintained a predetermined distance to obtain the highest printing quality. The apparatus ejects ink on printing paper moving on a paper supporting portion to form an image while the print head is moved left and right along a guide rod, and includes a gap detecting sensor disposed at a side portion of the print head, to output a signal which is changed according to a distance up to the printing paper put on the paper supporting portion; and a gap adjusting unit to adjust the gap between the print head and the printing paper according to the signal output from the gap detecting sensor.

### CROSS-REFERENCE TO RELATED APPLICATIONS

This application claims the benefit of Korean Application No. 2002-65865, filed Oct. 28, 2002, in the Korean Intellectual Property Office, the disclosure of which is incorporated herein by reference.

### BACKGROUND OF THE INVENTION

1. Field of the Invention

The present invention relates to an ink-jet printer, particularly, to an apparatus and method of adjusting a gap of an ink-jet print head, i.e., a gap between the ink-jet print head and printing paper.

2. Description of the Related Art

Generally, in an ink-jet printer in which a print head is mounted and the print head is laterally reciprocated along a guide rod so as to eject ink and thus form an image on the printing paper, an upper surface of the paper and a nozzle surface of the print head needs to be maintained at a constant gap, in order to obtain a high printing quality.

The more the gap between the upper surface of the paper and the nozzle surface of the print head (hereinafter, called “gap of the print head”) is increased, the area where an ink droplet may be attached to the paper becomes greater, thereby lowering image quality. Also, in the case of the printing paper having a relatively large thickness or a very rough upper surface, if the gap of the print head is too narrow, the upper surface of the paper is directly contacted with the nozzle surface of the print head, thereby resulting in undesirable smearing of the ink.

Therefore, in order to maintain the highest printing quality of the ink-jet printer, the gap of the print head has to be set to be not too large or too small. In order to satisfy the above conditions, many apparatuses for adjusting the gap of the print head have been proposed and used.

As a first example, FIG. 1 shows a conventional apparatus for adjusting the gap d of the print head 10 using an eccentric guide rod 12. The gap d is between a nozzle 11 of the print head 10 and a paper 18. There is respectively formed an eccentric spindle 14 at both ends of the guide rod 12. A rotational supporting member 16 is disposed to support the eccentric spindle 14. Then, if the eccentric spindle 14 is rotated at a predetermined angle by an external force, a center axle of the guide rod 12 for substantially guiding the print head 10 is lifted up and down with respect to the printing paper.

At this time, for one method of applying the external force to the eccentric spindle 14, a lever (not shown) having a handle is provided at one of the ends of the eccentric spindle 14 to protrude to an outside portion of the apparatus for a user to manually rotate the lever, thus raising and lowering the print head 10. For another method, a power transmitting means (not shown) such as a gear is disposed at one of the ends of the eccentric spindle 14, and a power source, such as a motor, is provided to drive the power transmitting means, whereby the print head 10 is lifted up and down by controlling the apparatus itself.

In a second example, between the guide rod and the print head, there is provided a gap adjustment apparatus for moving the print head up and down. At this time, the apparatus is classified into a lever type which is manually adjusted by the user and an automatic adjustment type which uses a motor and a power transmitting means to lift up and down the print head by controlling the apparatus itself.

In a third example, the print head and the guide rod are fixed, and a paper supporting portion for supporting the printing paper is manually or electrically lifted up and down, thereby adjusting the gap of the print head.

Therefore, using the apparatus as described above, the user can properly adjust the gap of the print head according to a thickness of the paper to be printed.

However, regardless of the manual adjustment type using the lever and the automatic adjustment type using the motor in the above conventional gap adjustment apparatuses, there is a problem that the user has to separately adjust the gap of the print head according to the thickness of the paper to be printed.

If the user does not adjust the gap of the print head according to the thickness of the paper, the printing quality deteriorates or the printed matter is damaged.

In order to prevent inconvenience or printing defects, a switch for detecting the gap of the print head may be provided to the apparatus. The switch is set to detect a maximum gap and a minimum gap of the print head. Thus, since the gap of the print head is automatically adjusted to the maximum and minimum gap according to the type of the paper, the inconvenience or the printing defects can be prevented.

However, since the apparatus having the switch can recognize and set only the maximum and minimum gap, the apparatus cannot set the most suitable gap according to the various thicknesses of the papers. Therefore, there is another problem that the apparatus cannot always obtain the highest printing quality according to the various thicknesses of the papers.

Therefore, there is an increasing need for an apparatus for adjusting the gap of the print head, which can automatically adjust the gap of the print head according to the various thicknesses of the papers.

### SUMMARY OF THE INVENTION

Accordingly, it is an aspect of the present invention to provide an apparatus and method of adjusting a gap of a print head, which can automatically detect a gap between the print head and the printing paper to be printed and then automatically adjust the gap of the print head into the most suitable state for the highest printing quality.

Additional aspects and advantages of the invention will be set forth in part in the description which follows and, in part, will be obvious from the description, or may be learned by practice of the invention.

The foregoing and/or other aspects of the present invention are achieved by providing an apparatus to adjust a gap of a print head of an ink-jet printer which ejects ink on a printing paper moving on a paper supporting portion to form an image while the print head is moved in opposite directions along a guide rod, the gap being between the print head and the printing paper including a gap detecting sensor disposed at a side portion of the print head, to output a signal which is changed according to a distance to the printing paper on the paper supporting portion; and a gap adjusting unit to adjust the gap between the print head and the printing paper according to the signal output from the gap detecting sensor.

The gap detecting sensor may include a light emitting portion to generate light toward the printing paper and then reflected with respect to the printing paper; and a light receiving portion to receive the light reflected by the printing paper.

The gap detecting sensor may output a signal which is changed according to a quantity of the light input to the light receiving portion, and the gap detecting sensor may be so that the quantity of the light input to the light receiving portion is maximum when the gap is a gap to form a highest printing quality.

The gap detecting sensor may also serve as a paper alignment detecting sensor to detect an aligning state of the printing paper on the paper supporting portion.

The gap adjusting unit may lift up and down the print head in opposite directions to adjust the gap between the print head and the printing paper supporting portion in opposite directions to adjust the gap between the print head and the printing paper.

The foregoing and/or other aspects of the present invention may be achieved by providing a method of adjusting a gap of a print head of an ink-jet printer which includes a paper supporting portion on which a sheet of printing paper is positioned; the print head moves in opposite directions along a guide rode, to eject ink on the printing paper and form an image, the gap being between the print head and the printing paper; a gap adjusting unit to lift up and down the print head with respect to the printing paper; and a gap detecting sensor which includes a light emitting portion disposed at a side portion of the print head so that light generated from the light emitting portion is reflected by the printing paper and then the reflected light is directed with respect to the printing paper and a light receiving portion to receive the light reflected by the printing paper, an output of the light receiving portion being changed according to a quantity of the light input to the light receiving portion, the method including positioning the printing paper on the paper supporting portion; moving the print head using the gap adjusting unit so that the gap detecting sensor is placed at a detecting reference position; and detecting a position that a maximum output is generated from the gap detecting sensor while moving the print head with the gap adjusting unit.

The detecting reference position may be a position that the gap between the print head and the printing paper becomes maximum.

The maximum output detecting operation may include operating the gap detecting sensor; storing the output of the gap detecting sensor; moving the gap detecting sensor a predetermined distance using the gap adjusting unit; determining whether a number of times that the gap detecting sensor is moved reaches a predetermined value, and repeating the storing of the output value if the determined number of times is less than the predetermined value; and searching for a maximum value of the stored outputs of the gap detecting sensor if the determined number of times is greater than the predetermined value.

As described above, according to the apparatus and method of adjusting the gap of the print head of the embodiment of the present invention, since the gap between the printing paper to be printed and the print head is automatically detected and then, automatically adjusted so as to maintain the most suitable gap, it is possible to always obtain the highest printing quantity regardless of a thickness and type of the printing paper.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a view showing an example of an apparatus for adjusting a gap of a print head in a conventional ink-jet printer;

FIG. 2 is a perspective view of an apparatus for adjusting the gap of the print head in an ink-jet printer according to an embodiment of the present invention;

FIG. 3 is a cross-sectional view of a gap detecting sensor of FIG. 2;

FIGS. 4A, 4B and 4C are views showing a status of detecting a gap between the printing paper and the print head using the gap detecting sensor, wherein FIG. 4A is a cross-sectional view of the gap detecting sensor in the case of the most suitable gap of the print head; FIG. 4B is a cross-sectional view of the gap detecting sensor in the case when the gap of the print head is too wide; and FIG. 4C is a cross-sectional view of the gap detecting sensor in the case when the gap of the print head is too narrow;

FIG. 5 is a flow chart showing a method of adjusting the gap of the print head in the ink-jet printer using the apparatus according to the embodiment of the present invention;

FIG. 6 is a flow chart showing an embodiment of the method of FIG. 5 to carry out an operation of searching a position in which a maximum output of the gap detecting sensor is generated; and

FIG. 7 is a flow chart showing additional operations of the embodiment of the method of FIG. 5.

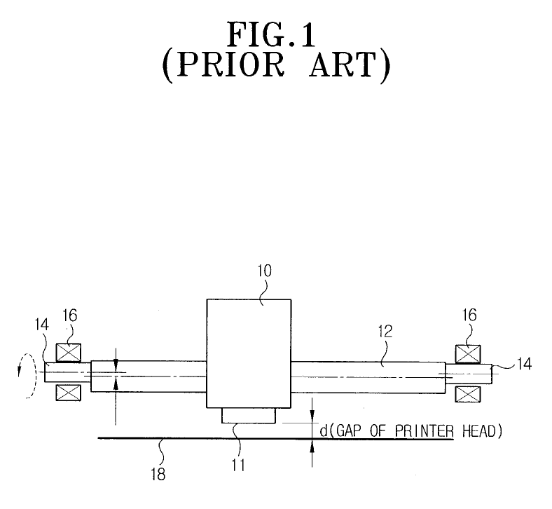

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

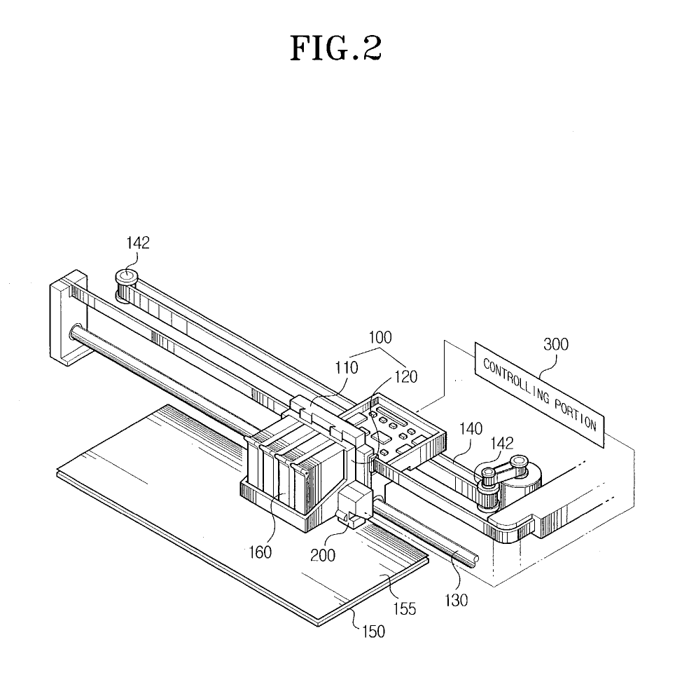

Referring to FIG. 2, an apparatus to adjust a gap of a print head according to an embodiment of the present invention includes a gap detecting sensor 200, a gap adjusting unit 100 and a controlling portion 300.

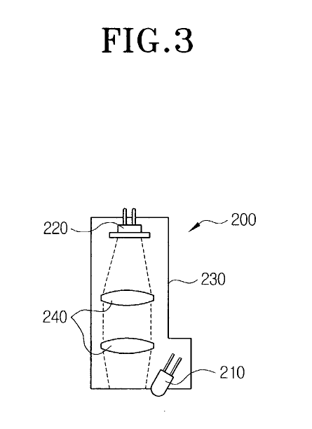

The gap detecting sensor 200 is disposed at a side of a print head 160. An example of the gap detecting sensor 200 is shown in FIG. 3. The gap detecting sensor 200 includes a light emitting portion 210 as an optical sensor, a light receiving portion 220 and a housing 230.

The light emitting portion 210 is used as a light source to generate light, and is positioned such that the light generated from the light emitting portion 210 is directed to a sheet of a printing paper 155 on a paper supporting portion 150 positioned under the print head 160, and the light is reflected from the printing paper in a perpendicular direction with respect to the printing paper. Typically, an LED is used as the light emitting portion 210.

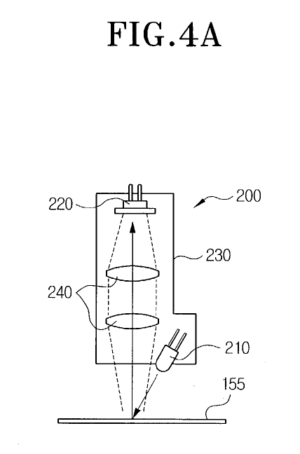

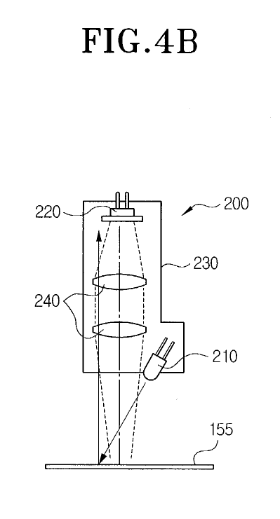

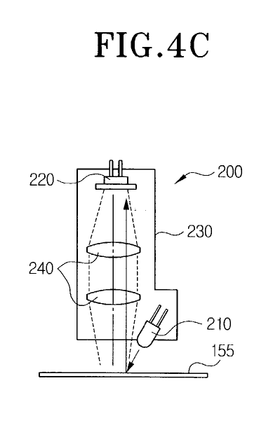

The light receiving portion 220 is disposed at an upper side of the light emitting portion 210 to receive the reflected light which is output from the light emitting portion 210 and then reflected from the printing paper 155. The light receiving portion 220 is disposed in the position where the reflected light is incident. In this situation, a relative position between the light emitting portion 210 and the light receiving portion 220 is set such that the light output from the light emitting portion 210 is maximally input to the light receiving portion 220 when the gap between an ink nozzle surface of the print head and an upper surface of the printing paper, i.e., the gap of the print head, can obtain the highest printing quality. In other words, when the ink nozzle surface and the upper surface of the printing paper have the gap that can obtain the highest printing quality (hereinafter, called “the most suitable gap of the print head”), since the light reflected by the printing paper is input to a center portion of the light receiving portion 220, as shown in FIG. 4A, the largest quantity of light is input to the light receiving portion 220. However, when the gap of the print head is too narrow (see FIG. 4C) or too wide (see FIG. 4B) in comparison with the most suitable gap, since the light reflected by the printing paper is not input to the center portion of the light receiving portion 220, a smaller quantity of light is input to the light receiving portion 220 as compared to the case of the most suitable gap of the print head.

The light receiving portion 220 changes a signal output from the light receiving portion 220 according to a quantity of the input light. That is, a sensor for which an output from the light receiving portion 220 is proportional to the quantity of light input to the light receiving portion 220 is used. The sensor having a voltage from the light receiving portion 220 is proportional to the quantity of light input to the light receiving portion 220.

Furthermore, a lens 240 may be disposed at a path through which the light is input to the light receiving portion 220 such that there is a clear difference between the quantity of light reflected by the printing paper and then input to the light receiving portion 220 when the gap of the print head is in the most suitable state, and the quantity of light reflected by the printing paper and then input to the light receiving portion 220 when the gap of the print head is not in the most suitable state.

The housing 230 supports and fixes the light emitting portion 210 and the light receiving portion 220 so that the light emitting portion 210 and the light receiving portion 220 can maintain relative positions to each other. If the lens 240 is provided, the housing 230 also fixes the lens 240. Further, the housing 230 allows the gap detecting sensor 200 to be fixed to the print head 160.

A sensor may be provided as the gap detecting sensor 200 to measure the gap between the printing paper and the ink nozzle surface of the print head, or, in case of the ink-jet printer having a sensor for detecting an alignment state of the printing paper placed on the paper supporting portion, the paper alignment detecting sensor may serve as the gap detecting sensor 200.

The gap adjusting unit 100 is disposed between the print head 160 and the guide rod 130 to lift the print head 160 up and down with respect to the printing paper 155. Further, the gap adjusting unit 100 allows the print head 160 to be reciprocated left and right along the guide rod 130 by a belt 140 and a pulley 142. The gap adjusting unit 100 includes a moving portion 120 disposed at the print head 160 and a fixing portion 110 disposed at the guide rod 130. Any of the well-known linear reciprocating devices, which can move linearly according to an electric signal, may be used as the gap adjusting unit 100.

The linear reciprocating device includes a moving portion to guide the linear motion and a driving portion to generate the linear motion. A rail, a linear guide, a guide rode, etc., may be used as the moving portion. A rack and pinion, a ball screw, a screw mechanism to convert a rotational motion of a motor into linear motion, etc., or a linear motor to directly generate the linear motion, etc., may be used as the driving portion.

The controlling portion 300 lifts the moving portion 120 of the gap adjusting unit 100 up and down, and receives and stores a signal from the gap detecting sensor 200 so as to search a position in which the gap detecting sensor 200 generates a maximum output.

Referring to FIGS. 2 and 3, an operation of searching the most suitable gap of the print head according to the type of the printing paper using the apparatus as described above will be described.

If a printing order is input, the ink-jet printer transfers the printing paper 155 to the paper supporting portion 150. When the printing paper 155 is positioned at the paper supporting portion 150, the gap adjusting unit 100 lifts up the moving portion 120 so that the gap of the print head 160 is the widest. Then, the gap detecting sensor 200 is operated so that the light is output from the light emitting portion 210. The output light is reflected by the printing paper 155 and then input to the light receiving portion 220. At this time, the light receiving portion 220 outputs a signal, which is proportional to a quantity of the input light, to the controlling portion 300. The controlling portion 300 stores the signal from the light receiving portion 220 and then outputs a signal to move down the moving portion a predetermined distance to the gap adjusting unit 100. Therefore, the moving portion 120 of the gap adjusting unit 100 is moved down the predetermined distance. Then, the gap detecting sensor 200 emits the light again, and the light reflected by the printing paper is input to the light receiving portion 220. Sequentially, the light receiving portion 220 outputs a signal, which is proportional to a quantity of the input light, to the controlling portion 300. The controlling portion 300 stores the signal from the light receiving portion 220 and then outputs a signal to move down the print head 160 a predetermined distance to the gap adjusting unit 100. These processes are repeated until the gap detecting sensor 200 is lifted down to the lowest position. If the gap detecting sensor 200 is lifted down to the lowest position, the controlling portion 300 searches a position, which generates the maximum output, from the stored signals from the light receiving portion 220. Then, the controlling portion 300 transfers a movement order to the gap adjusting unit 100 so that the print head 160 is moved to the position in which the light receiving portion 220 of the gap detecting sensor 200 generates a maximum output, thereby setting the gap of the print head.

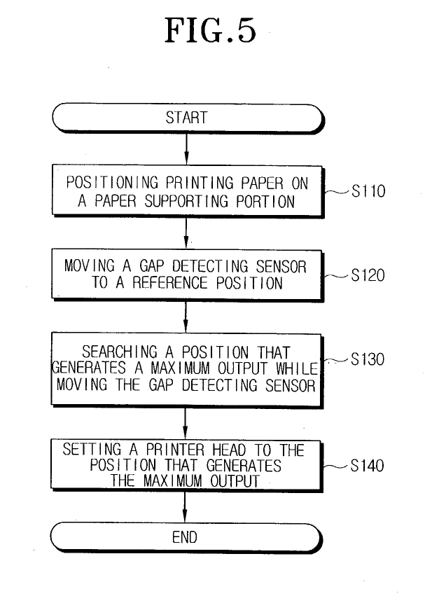

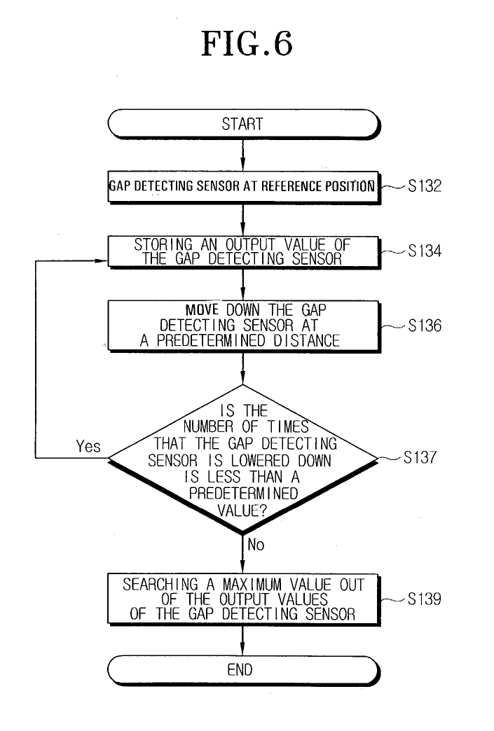

Referring to FIGS. 5 and 6, a method of adjusting the gap of the print head using the apparatus as described above will be described.

If a printing order is input, the ink-jet printer transfers the printing paper 155 to the paper supporting portion 150 (S110). The print head 160 is moved along the guide rod 130 to be positioned above the printing paper 155. Then, the gap adjusting unit 100 moves the gap detecting sensor 200 to a reference position (S120). The reference position of the gap detecting sensor 200 serves as a reference point to detect the optimum print head gap, and can be determined based on the method of finding out the position where the maximum output of the gap detecting sensor 200 is obtained, such as the position nearest to, or farthest from the printing paper. In this embodiment, a position that is farthest away from the printing paper is selected as the reference position of the gap detecting sensor 200. Therefore, the gap adjusting unit 100 moves the print head 160 to an upper side, positioning the gap detecting sensor 200 farthest away from the printing paper 155.

Sequentially, the gap adjusting unit 100 searches the position in which the maximum output is generated from the gap detecting sensor 200, while moving the gap detecting sensor 200 (S130) and sets the print head 160 to the position that generates the maximum output (S140). In FIG. 6, there is provided one embodiment of the way of searching the position in which the maximum output is generated from the gap detecting sensor 200.

Referring to FIG. 6, first, the gap detecting sensor 200 is operated in a state in which the gap detecting sensor 200 is placed at the reference position (S132). Then, light is output from the light emitting portion 210, and reflected by the printing paper 155, and then the light reflected by the printing paper 155 is input to the light receiving portion 220. The light input to the light receiving portion 220 is converted into electric energy to generate an output voltage proportional to the quantity of the input light and then transfers the output voltage to the controlling portion 300. The controlling portion 300 stores the output value from the light receiving portion 220 of the gap detecting sensor 200 (S134), and then outputs an order for the gap adjusting unit 100 to move down the moving portion 120 a predetermined distance (S136). At this time, the descent distance of the gap adjusting unit 100 is properly decided according to a maximum gap between the nozzle surface of the print head 160 and the upper surface of the printing paper and a moving accuracy of the gap adjusting unit 100.

After the gap adjusting unit 100 is moved down the predetermined distance, the controlling unit 300 determines whether the number of times that the gap detecting sensor 200 is moved down is less than a predetermined value (S137). At this time, the predetermined value is decided according to the maximum gap between the nozzle surface of the print head and the upper surface of the printing paper and the descent distance, which is decided according to the type of the inkjet printer. If the number of times that the gap detecting sensor 200 is moved down is less than the predetermined value, the controlling portion 300 goes to operation S134 and stores the output value from the light receiving portion 220. After storing the output value, the controlling portion 300 transfers again the order for the gap adjusting unit 100 to move down the moving portion 120 a predetermined distance (S136). These processes are repeated until the number of times that the gap detecting sensor 200 is moved down is greater than the predetermined value.

If the number of times that the gap detecting sensor 200 is moved down is greater than the predetermined value, the controlling portion 300 stops the operation of moving down the moving portion 120 of the gap adjusting unit 100, and then searches the largest value from the stored output values from the light receiving portion 220 (S139). At this time, since each output value of the light receiving portion 220 and the position of the gap detecting sensor 100 are specified, if the controlling portion 300 searches the maximum output value from the light receiving portion 220, it is possible to check the position of the gap detecting sensor at that time.

After checking the position of the gap detecting sensor 200, the controlling portion 300 transfers an order for the gap adjusting unit 100 to move the gap detecting sensor 200 to the position that the output value from the light receiving portion 220 becomes maximum. Since the position that the output value from the light receiving portion 220 is maximum at the most suitable gap of the print head, the ink-jet printer can obtain the highest printing quality at that position.

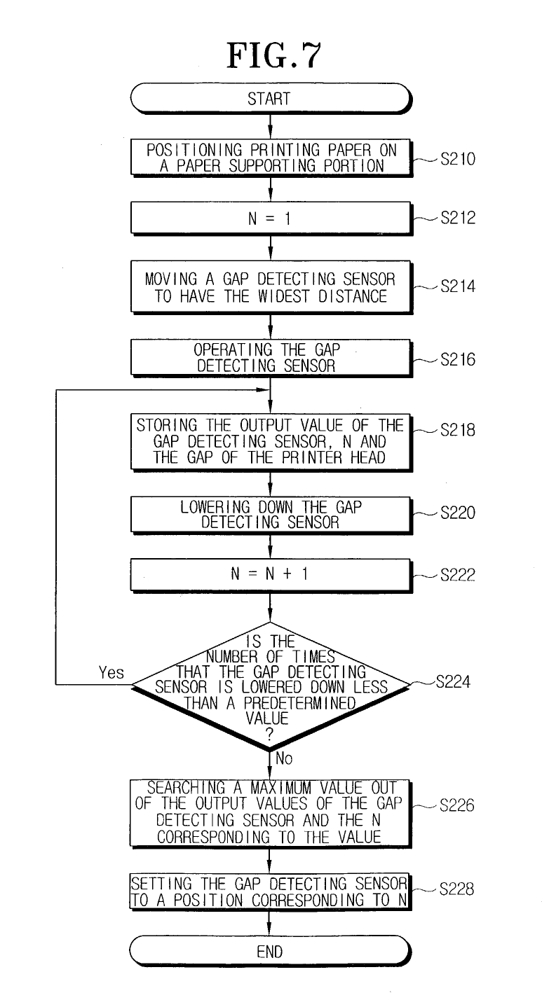

FIG. 7 shows additional operations of the method of specifying and storing the output value of the light receiving portion and the position of the gap detecting sensor in the controlling portion.

Referring to FIG. 7, first, the printing paper is positioned on the paper supporting portion (S210). The number N of times that the gap detecting sensor 200 is moved down is set to 1 (S212). Then, after the gap detecting sensor is moved to the position that the gap of the print head is furthest away from the printing paper (S214), the gap detecting sensor is operated (S216). And the output value from the light receiving portion of the gap detecting sensor, the number N of times that the gap detecting sensor 200 is moved down and the gap of the print head are stored in the controlling portion (S218). After finishing the storing process, the gap detecting sensor is moved down a predetermined distance (S220), and a value of 1 is added to the number N of times that the gap detecting sensor 200 is moved down (S222). The added new value is set to the number N of times that the gap detecting sensor 200 is moved down, and then it is determined again whether the number N of times that the gap detecting sensor 200 is moved down is less than the predetermined value (S224). If the number N of times that the gap detecting sensor 200 is lifted down is less than the predetermined value, it is returned to operation S218 so that the output value from the light receiving portion of the gap detecting sensor, the number N of times that the gap detecting sensor 200 is moved down and the gap of the print head are stored in the controlling portion, and then the same processes are carried out again.

If the number N of times that the gap detecting sensor 200 is moved down is larger than the predetermined value, the controlling portion searches a maximum value from the stored output values of the light receiving portion (S226), and checks the number N at the maximum value. Then, the controlling portion transfers an order for the gap adjusting so that the moving portion is operated and thus the gap detecting sensor is placed at a position corresponding to the number N having the maximum output value of the light receiving portion (S228).

As described above, according to the apparatus and method of adjusting the gap of the print head of the embodiment of the present invention, the gap detecting sensor detects a distance to the printing paper, and the most suitable gap of the print head can be maintained using the apparatus. Therefore, a user does not need to directly adjust the gap of the print head according to a thickness of the printing paper. Since the most suitable gap of the print head can be always maintained, it is possible to always obtain the highest printing quality.

Although a few preferred embodiments of the present invention have been shown and described, it will be appreciated by those skilled in the art that changes may be made in these embodiments without departing from the principles and spirit of the invention, the scope of which is defined in the claims and their equivalents.

What is claimed is:

1. An apparatus to adjust a gap of a print head of an ink-jet printer which ejects ink on a printing paper moving on a paper supporting portion to form an image while the print head is moved in opposite directions along a guide rod, the gap being between the print head and the printing paper, the apparatus comprising:
a gap detecting sensor disposed at a side portion of the print head, to output a signal which is changed according to a distance to the printing paper on the paper supporting portion; and
a gap adjusting unit to adjust the gap between the print head and the printing paper according to the signal output from the gap detecting sensor.

2. The apparatus of claim 1, wherein the gap detecting sensor comprises:
a light emitting portion to generate light toward the printing paper to be reflected with respect to the printing paper; and
a light receiving portion to receive the light reflected by the printing paper.

3. The apparatus of claim 2, wherein the gap detecting sensor outputs a signal which is changed according to a quantity of the light received by the light receiving portion.

4. The apparatus of claim 3, wherein the quantity of the light input to the light receiving portion is maximum when the gap is to provide a highest printing quality.

5. The apparatus of claim 4, wherein the gap detecting sensor is a paper alignment detecting sensor to detect an aligning state of the printing paper on the paper supporting portion.

6. The apparatus of claim 4, wherein the gap adjusting unit moves the print head in opposite directions to adjust the gap between the print head and the printing paper.

7. The apparatus of claim 4, wherein the gap adjusting unit moves the paper supporting portion in opposite directions to adjust the gap between the print head and the printing paper.

8. A method of adjusting a gap of a print head of an ink-jet printer which comprises a paper supporting portion on which a sheet of printing paper is positioned, the print head moving in opposite directions along a guide rod, to eject ink on the printing paper and form an image, the gap being between the print head and the printing paper; a gap adjusting unit to move the print head with respect to the printing paper; and a gap detecting sensor which comprises a light emitting portion disposed at a side portion of the print head so that light generated from the light emitting portion is reflected by the printing paper and then the reflected light is directed with respect to the printing paper, and a light receiving portion to receive the light reflected by the printing paper, an output of the light receiving portion being changed according to a quantity of the light received by the light receiving portion, the method comprising:
positioning the printing paper on the paper supporting portion;
moving the print head using the gap adjusting unit so that the gap detecting sensor is placed at a detecting reference position;
detecting a position that a maximum output is generated from the gap detecting sensor while moving the print head with the gap adjusting unit; and
setting the print head to the maximum output position.

9. The method of claim 8, wherein the detecting reference position is a position at which the gap between the print head and the printing paper becomes maximum.

10. The method of claim 9, wherein the detecting of the maximum output position comprises:
operating the gap detecting sensor to emit and receive the light;
storing the output of the gap detecting sensor;
moving the gap detecting sensor a predetermined distance using the gap adjusting unit;
determining whether a number of times that the gap detecting sensor is moved reaches a predetermined value, and repeating the storing of the output value if the determined number of times is less than the predetermined value; and
searching for a maximum value of the stored outputs of the gap detecting sensor if the determined number of times is greater than the predetermined value.

11. An ink-jet printer in which a print head is moved in opposite directions along a guide rode and ejects ink to a printing paper on a paper supporting portion, which is located below the print head, to form an image, comprising:
a light emitting portion disposed at the print head so that light emitted from the light emitting portion to the printing paper is reflected with respect to the printing paper;
a light receiving portion disposed at the print head to receive the light reflected by the printing paper and to output a signal according to a quantity of the received light;
a controlling portion to receive the signal output from the light receiving portion; and
a gap adjusting unit disposed between the print head and the guide rod, to move the print head in opposite directions according to a signal from the controlling portion,
wherein the gap adjusting unit is controlled by the signal output from the light receiving portion so as to maintain a most suitable gap between the print head and the printing paper.

12. The inkjet printer of claim 11, wherein the light emitting portion is set so that a quantity of the light input to the light receiving portion becomes maximum when the print head has a predetermined gap for forming a highest printing quality.

13. An apparatus comprising:
a head to print an image on a paper;
a sensor to detect distances between the head and the paper and to output signals according to the detected distances; and
an adjustor to adjust a printing gap between the head and the paper according to the output signals.

14. The apparatus of claim 13, wherein the sensor comprises:
an emitter to emit a light to the paper to be reflected by the paper; and
a receiver to receive the reflected light, the output signals being based on a quantity of the received light.

15. The apparatus of claim 14, wherein the reflected light is perpendicular to the emitted light.

16. The apparatus of claim 14, wherein the sensor further comprises a lens disposed on a path of the light between the emitter and the receiver.

17. The apparatus of claim 16, wherein the emitter is displaced from and at an angle with respect to an optical axis of the lens.

18. An apparatus comprising:
a head to print an image on a paper; and
an adjustor to automatically adjust a printing gap between the head and the paper to achieve a highest image quality based on a thickness of the paper.

19. The apparatus of claim 18, further comprising a sensor to detect distances between the head and the paper, wherein the adjustor adjusts the printing gap to achieve the highest image quality based on the detected distances.

20. A method comprising:
moving a print head to positions between a first and a second distance from a printing paper;
detecting light reflected from the paper at the positions; and
automatically adjusting a printing gap between the print head and the printing paper to achieve a highest image quality based on the detected light.
